(19) United States
(12) Patent Application Publication
(10) Pub. No.: US 2018/0114664 A1
(43) Pub. Date: Apr. 26, 2018

(54) Switch Assembly with Multi-Function Compound Switches

(71) Applicant: Alexandru Salagean, Mississauga (CA)

(72) Inventor: Alexandru Salagean, Mississauga (CA)

(21) Appl. No.: 15/708,761

(22) Filed: Sep. 19, 2017

Related U.S. Application Data
(60) Provisional application No. 62/413,209, filed on Oct. 26, 2016.

(51) Int. Cl. H01H 89/00; H01H 23/00; H01H 23/04; H01H 23/08; H01H 23/12; H01H 15/10; H01H 15/04

(52) U.S. Cl. CPC H01H 89/00; H01H 23/006; H01H 23/04; H01H 23/08; H01H 2300/008; H01H 15/10; H01H 15/04; H01H 2231/026; H01H 23/12

(57) ABSTRACT

In one aspect, a switch assembly includes a switch housing that includes one or more compound switches, each comprising a first switch and a second switch embedded within the first switch. Each compound switch includes a first subassembly of constituent parts that includes the first switch and implements a first switching function. Each compound switch also includes a second subassembly of constituent parts embedded within and carried by the first subassembly of constituent parts. The second subassembly of constituent parts includes the second switch and implements a second switching function that is distinct from the first switching function. The switch assembly includes one or more extended plungers and corresponding guiding features that advantageously allow for the use of a single keypad and PCB with respect to the compound switches.

### RELATED APPLICATIONS

This application claims priority to and benefit of U.S. provisional patent application Ser. No. 62/413,209, filed 26 Oct. 2016.

### TECHNICAL FIELD

The present invention relates to low-current power switches with integrated multi-functional compound switches, such as may be used in power seat switch applications in vehicles.

### BACKGROUND

Various automotive functions and features rely on electrical switches for actuation and control. From power windows to power seats, the typical automotive interior includes a multiplicity of electrical switches having various configurations.

Interior space within the average vehicle comes at a premium, however, and the lack of available space complicates the positioning and packaging of switches. Ergonomic and aesthetic concerns exacerbate the packaging and placement challenges, and the promise of ever greater luxury and convenience in contemporary vehicles only adds to the need for attractive, reliable, and affordable switching solutions.

### SUMMARY

According to some embodiments, a switch assembly includes a switch housing that includes a compound switch comprising a first switch and a second switch embedded within the first switch. The compound switch includes a first subassembly of constituent parts that includes the first switch and implements a first switching function. The compound switch also includes a second subassembly of constituent parts embedded within and carried by the first subassembly of constituent parts. The second subassembly of constituent parts includes the second switch and implements a second switching function that is distinct from the first switching function.

Of course, the present invention is not limited to the above features and advantages. Those of ordinary skill in the art will recognize additional features and advantages upon reading the following detailed description, and upon viewing the accompanying drawings.

### BRIEF DESCRIPTION OF THE DRAWINGS

FIG. 1 illustrates a perspective view of one embodiment of two compound switches.

FIG. 2 illustrates an arrangement of parts in one embodiment of a first compound switch in the switch assembly of FIG. 1.

FIG. 3 illustrates the same arrangement of parts of FIG. 2 in a contemplated stacking arrangement for a compound switch.

FIG. 4 illustrates an exploded view of one embodiment of an overall switch assembly that includes two compound switches and provides advantageous mechanical and electrical simplifications.

### DETAILED DESCRIPTION

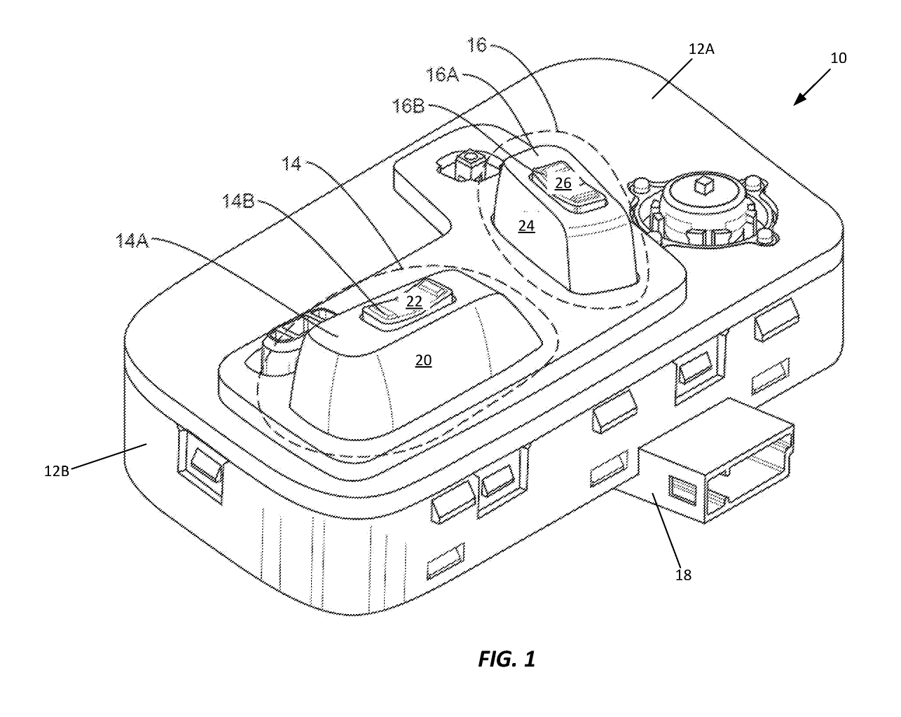

FIG. 1 provides a perspective view of one embodiment of a switch assembly 10. The illustrated switch assembly 10 includes a switch cover 12A, which may snap to or join with a corresponding base 12B, to form a switch housing. The switch assembly 10 includes one or more control switches. In an example embodiment, the switch assembly 10 comprises a power seat switch assembly that includes multiple control switches corresponding to various seat controls as might be implemented for a seat in a passenger car or another type of vehicle. Advantageously, the switch assembly 10 includes “stacked” or “combined” functionality in one or more of the control switches. With this approach, a given switch integrates or embeds another switch within its assembly and may be referred to as a “combined” or “compound” switch.

A compound switch as contemplated in one or more embodiments herein includes a first switch and at least one second switch embedded within the first switch. The first and second switches provide distinct control actions, although the control actions may be related or complementary. Notably, the compound switch arrangements contemplated in this disclosure simplify internal mechanical and electrical aspects of the overall switch assembly 10, yielding gains in economy and reliability.

In a compound switch that includes first and second switches, the first switch may be referred to as a main or primary switch and the second switch may be referred to as an embedded or secondary switch. Control switches 14 and 16 in FIG. 1 comprise “compound switches” within the meaning of this disclosure. The compound switch 14, for example, includes a primary or first switch 14A that is configured as a sliding-type switch, e.g., for adjusting the cushions of a passenger seat. The compound switch 14 further includes a secondary switch 14B that is configured as a rocker-type switch, e.g., for adjusting a seat bolster.

As a further example, the switch assembly 10 includes another compound switch, denoted as compound switch 16. The compound switch 16 comprises a primary or first switch 16A configured as a two-way, sliding-type switch, e.g., for adjusting a seat back of an automotive seat. Further, the compound switch 16 includes a secondary switch 16B that is embedded in the first switch 16A and is configured as a rocking-type switch, e.g., for adjusting the bolsters of the seat back.

The overall switch assembly 10 may include one or more such compound switches and may include additional, non-compound switches. Further, a wiring or connector port 18 provides for connection of the switch assembly 10 to power and/or other wiring connections for the various switches included in the assembly 10, and it may be integrated into the base portion 12B.

It should be appreciated that unless otherwise noted, the term “switch” broadly means the collection of parts or components associated with a particular control action—e.g., seat cushion adjustment, bolster adjustment, etc. Thus, unless otherwise noted in context, the term “switch” can be understood as referring to any subassembly of constituent parts configured for implementing a switching action. Along those lines, it will be appreciated that the switches 14 and 16 include constituent parts not visible in the FIG. 1.

In at least some embodiments, the reference number 14 in FIG. 1 denotes a compound switch 14 comprising a sliding-type switch 14A for seat cushion adjustment via an operator-accessible switch knob 20. The compound switch 14 further includes a rocker-type switch 14B for seat bolster adjustment via an operator accessible switch knob 22. In at least one such embodiment, the compound switch 16 includes a slider-type switch 16A for seatback adjustment via an operator-accessible switch knob 24, and a rocker-type switch 16B for seatback bolster adjustment via an operator-accessible switch knob 26. Here, the term “operator” refers to a human user of the switch assembly 10.

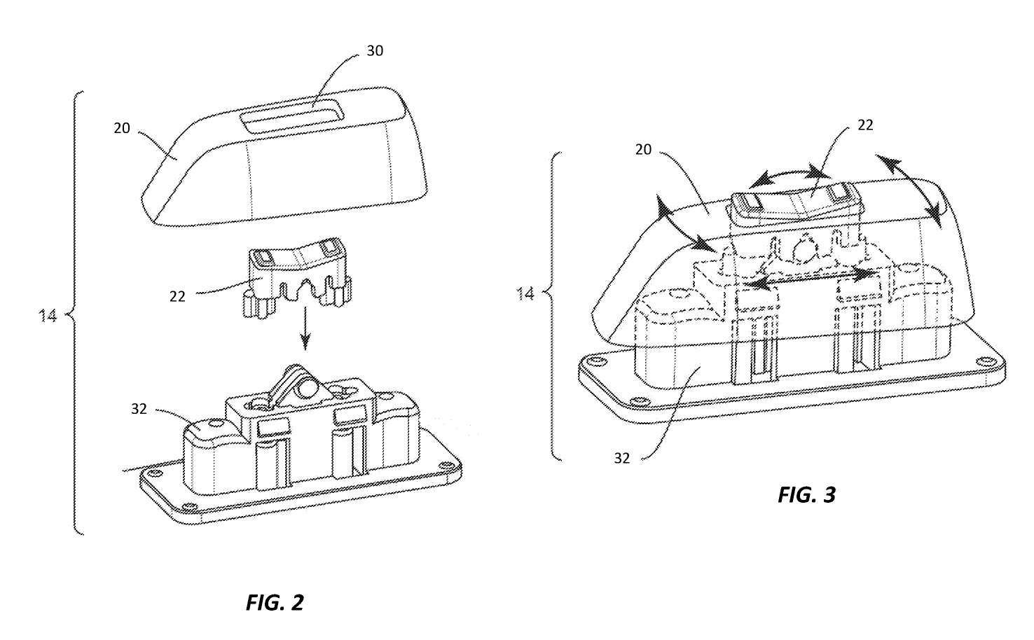

FIG. 2 continues the example illustrations for the compound switch 14, where the first switch knob 20 is associated with the main or primary switch 14A, and includes an aperture 30 through which the second switch knob 22 of the second or embedded switch 14B projects. The second switch knob 22, also referred to as a rocking member 22, snaps or mounts in a pivoting arrangement onto a switch actuator 32 that is associated with the main or primary switch 14A. FIG. 3 illustrates the same arrangement of parts in a contemplated stacking arrangement.

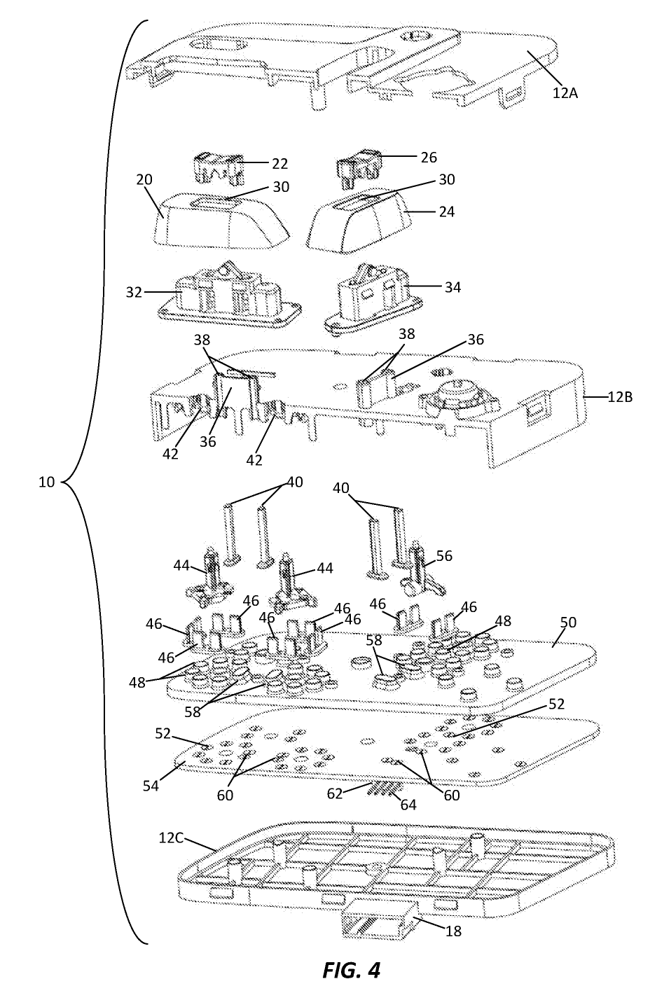

FIG. 4 provides further details regarding an example embodiment of the contemplated switch assembly 10, including details related to internal mechanical and electrical simplifications. In addition to the previously illustrated cover 12A and base 12B, the switch assembly 10 in some embodiments includes a bottom cover 12C. The top and bottom covers 12A and 12C snap to or otherwise assemble with the base 12B to form an overall housing for the constituent switch parts of the switch assembly 10.

As noted above, the two switch knobs 20 and 24 have apertures 30, which expose the respective second switch knobs 22 and 26 for actuation by a user. The switch knob 20 snaps to or otherwise “rides” on the switch actuator 32, which also provides a point of pivoting attachment for the switch knob 22. The switch actuator 34 provides similar functionality and interconnection with respect to the switch knobs 24 and 26.

The base 12B includes switch actuator mounts 36 for aligning and carrying the respective switch actuators 32 and 34, where the switch actuator mounts 36 may be molded into the base 12B. Advantageously, the switch actuator mounts 36 each include internal guiding features, e.g., cylindrical channels 38, for guiding and retaining respective pairs of extended plungers 40. The base 12B includes further alignment and retention features 42, e.g., molded cavities, for retaining and aligning a pair of switch actuation elements 44, that are actuated by sliding movement of the switch knob 20/switch actuator 32.

Sliding movement of the switch knob 20 in the finished switch assembly 10 tilts one or the other of the two switch actuation elements 44, which causes the switch actuation element 44 to press down on a respective keypad interface element 46, thereby actuating one or more corresponding key(s) 48 included in an elastomeric keypad 50 contained in the overall stack of constituent parts comprising the switch assembly 10. Depressing the flexible, elastomeric key(s) 48 downward causes the conductive underside of the key(s) 48 to contact an exposed key contact 52 on a Printed Circuit Board (PCB) 54 that is included in the overall stack of constituent parts comprising the switch assembly 10. For example, the key contact 52 comprises two metalized areas on the PCB 54 which are electrically connected by bridging contact of the key 48.

A similar arrangement exists for the switch actuator 34, which, via user manipulation of the switch knob 24, operates on an actuator element 56 that actuates corresponding keys 48 on the elastomeric keypad 50 via respectively aligned keypad interface element 46. In turn, those corresponding keys 48 contact respectively underlying key contacts 52 on the PCB 54. As a general proposition, it will be appreciated that there is a vertical alignment in the stack of constituent parts—i.e., respective key contacts 52 on the PCB 54 are aligned with and underlie corresponding keys 48 on the elastomeric keypad 50.

For ease of discussion, FIG. 4 uses the reference number 58 to refer to keys on the elastomeric keypad 50 that are actuated by the extended plungers 40. For similar emphasis, FIG. 4 uses the reference number 60 to refer to key contacts on the PCB 54 that are contacted by the keys 58. This emphasis provides a basis for discussing at least some aspects of the mechanical and electrical simplifications provided by the illustrated switch assembly 10.

Namely, the extended plungers 40 and the corresponding internal guiding or alignment features 38 allow the second switch knobs 22 and 26 to use the same elastomeric keypad 50 and PCB 54 used by the first switch knobs 20 and 24. A known approach to implementation of compound switches involves having a first keypad and PCB for the main or primary switch function, and a further, secondary keypad and PCB for the embedded secondary switch function. With such an approach, the switch assembly 10 would have a small PCB and keypad positioned below the second switch knobs 22 and 26, with pigtail wiring or similar electrical interconnections going down to a “main” PCB that carried contacts for the main switches in the assembly. The arrangement illustrated in FIG. 4 obviates the need for these additional components—which complicate assembly, increase failure vulnerability, and drive costs upward—by mechanically coupling the second switch knobs 22 and 26 to the “main” elastomeric keypad 50 and PCB 54 via use of the extended plungers 40.

The contemplated arrangement works reliably and offers good tactile feel as part of the overall arrangement, including the internal guiding features 38, which retain, guide, and align the extended plungers 40 within the assembled switch assembly 10. Using the second switch knob 22 as an example for discussion, its corresponding pair of extended plungers 40 are exposed at respective first ends for downward actuation via rocking movement of the rocking member (switch knob 22). The extended plungers 40 extend vertically downward through one or more internal guiding features 38, for actuation of respective keys 58 on the elastomeric keypad 50 via corresponding keypad interface elements 46.

The extended plungers 40 corresponding to the second switch knob 22 have a length that preloads the second switch knob 22 to a rest position with respect to its designed for rocker movement. A similar arrangement applies with respect to the second switch knob 26 and its corresponding pair of guided, extended plungers 40.

Reduced parts count and better environmental protection number among the several advantages provided by the compound switch arrangements contemplated in this disclosure. For example, use of the extended plungers 40 in the compound switch 14 or 16 allows the overall compound switch 14 or 16 to use an elastomeric keypad 50 and corresponding PCB 54 positioned at the bottom of the overall stacking arrangement. In other words, the arrangement allows for use of a single keypad/PCB within the overall switch assembly 10, thereby simplifying the overall arrangement and providing more robust interconnection to the switch assembly, e.g., via a set 62 of electrical pins 64 mounted to the PCB 54 and accessible via the connector 18 introduced in FIG. 1.

With the above points in mind, in one embodiment, the switch assembly 10 comprises a switch housing 12 that includes a compound switch, e.g., 14 or 16. The compound switch 14 or 16 includes a first switch 14A or 16A and a second switch 14B or 16B, wherein the second switch 14B or 16B is embedded within the first switch 14A or 16A. The second switch 14B or 16B implements a second switching function that is distinct from a first switching function implemented by the first switch 14A or 16A.

In at least one embodiment, the switch assembly 10 comprises a power seat switch assembly, wherein the first switch 14A or 16A provides a first power seat adjustment function and the second switch 14B or 16B provides a second power seat adjustment function. For example, the first switch 14A or 16A comprises a sliding-type switch configured for seat cushion adjustment and the second switch 14B or 16B comprises a rocker-type switch embedded in the sliding-type switch and configured for seat-bolster adjustment. In another example, the first switch 14A or 16A comprises a sliding-type switch configured for seatback adjustment and the second switch 14B or 16B comprises a rocker-type switch embedded in the sliding-type switch and configured for seatback bolster adjustment.

Further, in at least some embodiments, the switch assembly 10 includes a wiring port or connector 18 exposing electrical pins or contacts 64 that are electrically interconnected with the PCB 54, where the PCB 54 provides electrical interconnections for both the first switch 14A or 16A and the second switch 14B or 16B. Here, it will be appreciated that the extended plungers 40 provide a mechanical coupling between the second switch knob 22 and the corresponding keys 58 on the elastomeric keypad 50, despite the vertical separation between second switch knob 22 and the keypad 50 and underlying PCB 54 at the base or bottom of the switch assembly 10. As such, the inclusion of the extended plungers 40 obviates the need for the switch assembly 10 to include a supplemental keypad and PCB for the second switch 14B or 16B, and further obviates the need for any internal wiring pigtails, for electrically connecting such supplemental components to the lower PCB 54.

Notably, modifications and other embodiments of the disclosed invention(s) will come to mind to one skilled in the art having the benefit of the teachings presented in the preceding descriptions and the associated drawings. Therefore, it is to be understood that the invention(s) is/are not to be limited to the specific embodiments disclosed and that modifications and other embodiments are intended to be included within the scope of this disclosure. Although specific terms may be employed herein, they are used in a generic and descriptive sense only and not for purposes of limitation.

What is claimed is:

1. A switch assembly comprising:
a switch housing including a compound switch comprising a first switch and a second switch embedded within the first switch, the second switch implementing a second switching function that is distinct from a first switching function implemented by the first switch;
wherein the switch assembly includes a switch actuator associated with the first switch and engaged by a first switch knob provided in the switch assembly for actuation of the first switch by an operator;
wherein the switch assembly includes a second switch knob configured for snapping onto or otherwise mounting onto the switch actuator and projecting through an aperture in the first switch knob, for actuation of the second switch;
wherein the second switch knob comprises a rocking member, and wherein the switch assembly further includes a pair of extended plungers that are carried by the switch actuator and are independent of any actuating movement of the first switch knob, said extended plungers exposed at respective first ends for downward actuation via rocking movement of the rocking member, and extending vertically downward through one or more internal guiding features within an interior of the switch assembly, for actuation of respective keys on an elastomeric keypad that overlay respective key contacts on a Printed Circuit Board (PCB) included in the switch assembly; and
wherein the extended plungers have a length that preloads the second switch knob to a rest position.

2. The switch assembly of claim 1, wherein the switch assembly comprises a power seat switch assembly and wherein the first switch provides a first power seat adjustment function and the second switch provides a second power seat adjustment function.

3. The switch assembly of claim 2, wherein the first switch comprises a sliding-type switch configured for seat cushion adjustment and the second switch comprises a rocker-type switch embedded in the sliding-type switch and configured for seat-bolster adjustment.

4. The switch assembly of claim 2, wherein the first switch comprises a sliding-type switch configured for seatback adjustment and the second switch comprises a rocker-type switch embedded in the sliding-type switch and configured for seatback bolster adjustment.

5. The switch assembly of claim 1, wherein the switch assembly further includes a wiring port or connector having electrical contacts that are electrically interconnected with the PCB, and wherein said PCB provides key contacts for the first switch and key contacts for the second switch.
